(19) United States
(12) Patent Application Publication
(10) Pub. No.: US 2025/0218695 A1
(43) Pub. Date: Jul. 3, 2025

(54) CAPACITOR

(71) Applicant: Panasonic Intellectual Property Management Co., Ltd., Osaka (JP)

(72) Inventors: Kotaro ONO, OSAKA FU (JP); Yoshitaka NAKAMURA, OSAKA FU (JP); Hitoshi ISHIMOTO, HYOGO KEN (JP)

(21) Appl. No.: 18/844,331

(22) PCT Filed: Feb. 24, 2023
(86) PCT No.: PCT/JP2023/006860

§ 371 Date: Sep. 5, 2024

(30) Foreign Application Priority Data
Mar. 9, 2022 (JP) 2022-036524

(51) Int. Cl. H01G 9/048; H01G 9/032; H01G 9/045; H01G 9/07

(52) U.S. Cl. CPC H01G 9/048; H01G 9/032; H01G 9/045; H01G 9/07

(57) ABSTRACT

A capacitor disclosed includes an anode body having a dielectric layer formed on a surface of the anode body, and a conductive layer formed on the dielectric layer and made of a metal oxide. The conductive layer includes a first conductive layer formed on the dielectric layer, and a second conductive layer formed on the first conductive layer. The average thickness of the second conductive layer is larger than the average thickness of the first conductive layer.

### TECHNICAL FIELD

The present disclosure relates to a capacitor.

### BACKGROUND ART

Various capacitors have been conventionally proposed. PTL 1 (Japanese Laid-Open Patent Publication No. 2017-103412) discloses “a solid electrolytic capacitor comprising: an anode body; a dielectric layer disposed on a surface of the anode body; and a solid electrolyte layer disposed on a surface of the dielectric layer and constituted using zinc oxide having a conductivity of 1 (S/cm) or more”.

PTL 2 (Japanese Laid-Open Patent Publication No. 2020-35890) discloses “a solid electrolytic capacitor comprising: an anode body made of a valve metal; a dielectric layer formed on a surface of the anode body; a semiconductor layer formed on the dielectric layer; and a cathode layer formed on the semiconductor layer, in which the semiconductor layer is constituted by using an inorganic p-type semiconductor”.

### CITATION LIST

### Patent Literature

PTL 1: Japanese Laid-Open Patent Publication No. 2017-103412

PTL 2: Japanese Laid-Open Patent Publication No. 2020-35890

### SUMMARY OF INVENTION

### Technical Problem

In recent years, there has been demand for capacitors having high resistance to high temperatures. In such a situation, one object of the present disclosure is to provide a novel capacitor having high resistance to a high temperature.

### Solution to Problem

One aspect of the present disclosure relates to a capacitor. The capacitor includes an anode body having a dielectric layer formed on a surface of the anode body; and a conductive layer formed on the dielectric layer and made of a metal oxide, in which the conductive layer includes a first conductive layer formed on the dielectric layer, and a second conductive layer formed on the first conductive layer, and an average thickness of the second conductive layer is larger than an average thickness of the first conductive layer.

### Advantageous Effects of Invention

According to the present disclosure, it is possible to obtain a capacitor having high resistance to a high temperature.

While novel features of the present invention are set forth particularly in the appended claims, the present invention, both as to organization and content, will be better understood and appreciated, along with other objects and features thereof, from the following detailed description taken in conjunction with the drawings.

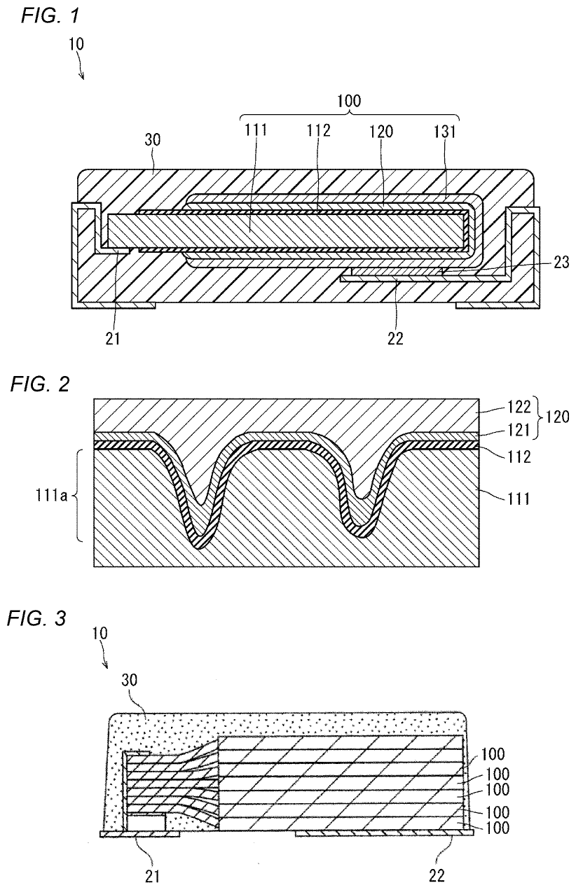

### BRIEF DESCRIPTION OF DRAWINGS

[FIG. 1] A cross-sectional view schematically showing a structure of an example of a capacitor according to this embodiment.

[FIG. 2] A cross-sectional view schematically showing a portion of the capacitor shown in FIG. 1.

[FIG. 3] A cross-sectional view schematically showing a structure of another example of the capacitor according to this embodiment.

### DESCRIPTION OF EMBODIMENTS

Although an embodiment according to the present disclosure will be described below using an example, the present disclosure is not limited to the example described below. Although specific numerical values and materials may be mentioned as examples in the following description, other numerical values and other materials may be used as long as the invention according to the present disclosure can be implemented. The term “range of numerical value A to numerical value B” used in this specification includes the numerical value A and the numerical value B, and can be read as “range of numerical value A or more to numerical value B or less”. In the following description, when lower limits and upper limits of numerical values regarding specific physical properties, conditions, or the like are given as examples, any of the above-mentioned lower limits and any of the above-mentioned upper limits can be combined, as long as the lower limit is not greater than or equal to the upper limit.

### Capacitor

A capacitor according to this embodiment includes an anode body having a dielectric layer formed on a surface of the anode body, and a conductive layer formed on the dielectric layer and made of a metal oxide. The capacitor and the conductive layer may be respectively referred to as a “capacitor (C)” and a “conductive layer (L)” hereinafter. The conductive layer (L) includes a first conductive layer formed on the dielectric layer, and a second conductive layer formed on the first conductive layer. The average thickness of the second conductive layer is larger than the average thickness of the first conductive layer.

In the capacitor (C), because the stress can be relieved by a first thin conductive layer, it is possible to inhibit the conductive layer (L) from separating from the dielectric layer even when exposed to a high temperature.

The capacitor (C) may further include a cathode extraction layer formed on the conductive layer and containing an inorganic conductive material. The capacitor (C) having this configuration does not include a solid electrolyte layer containing a conductive polymer, and thus has high resistance to a high temperature.

An average thickness T1 of the first conductive layer may be 1 nm or more or 5 nm or more, and 1 μm, 500 nm or less, 100 nm or less, or 50 nm or less. The average thickness T1 of the first conductive layer may be in a range of 1 nm to 1 μm, or in a range of 5 nm to 1 μm. In any of these ranges, the upper limit may be 500 nm, 100 nm, or 50 nm.

An average thickness T2 of the second conductive layer may be 50 nm or more or 100nm or more, and 50 μm or less, 20 μm or less, or 1 μm or less.

A ratio T2/T1 of the average thickness T2 of the second conductive layer to the average thickness T1 of the first conductive layer is more than 1, 10 or more, 100 or more, or 1000 or more, and 100000 or less, or 10000 or less.

The average thickness T1 of the first conductive layer can be measured as follows. First, a cross section of the first conductive layer is exposed, and an image of the cross section is acquired using an electron microscope. Then, the thickness of the first conductive layer can be determined by measuring the thicknesses at any ten points on the image. The average thickness T1 can be determined by taking the arithmetic average of the 10 measured values. The average thickness T2 of the second conductive layer can also be determined using the same method. Note that, when a boundary between the first conductive layer and the second conductive layer is unclear in a scanning electron microscope image, the boundary between the two layers can be identified through EDS (energy dispersive X-ray analysis) or electron beam diffraction using a STEM (scanning transmission electron microscope) or TEM (transmission electron microscope). The anode body may include a porous portion in its surface. In such a case, the dielectric layer is formed on the porous portion.

The conductivity of the second conductive layer may be 1 S/cm or more or 10 S/cm or more. The conductivity of the second conductive layer may be in a range of 1 S/cm to 10000 S/cm. It is expected that the ESR of the capacitor can be reduced by setting the conductivity of the second conductive layer to 1 S/cm or more. The conductivity of the first conductive layer is also preferably in the range mentioned above.

The conductive layer may be made of at least one selected from the group consisting of ZnO, TiO₂, indium tin oxide (ITO), In₂O₃, SnO₂, MnO₂, NiO₂, CuInO₂, CuCrO₂, CuAlO₂, and CuScO₂. In particular, ZnO, indium tin oxide (ITO), In₂O₃, CuInO₂, and CuCrO₂ are preferable because they have high conductivity.

Note that ZnO and the like are classified as conductors and are classified as semiconductors in some cases, but they are treated as conductors in this specification. The material of the first conductive layer may be different from or the same as the material of the second conductive layer. The first conductive layer and the second conductive layer are preferably made of the same material in order to improve adhesion between the first conductive layer and the second conductive layer. In a preferable example, the material of the first conductive layer and the material of the second conductive layer are both ZnO or both indium tin oxide.

The conductive layer may contain an impurity element for improving the conductivity of the conductive layer. The concentration of the impurity element may be in a range of 0.1 to 15 atomic %. The impurity element is selected depending on the material of a conductive layer. Only the first conductive layer may contain an impurity element, or only the second conductive layer may contain an impurity element. Alternatively, both the first and second conductive layers may contain an impurity element.

### Method for Producing Capacitor

An example of a method for producing a capacitor will be described below. The production method may be referred to as a “production method (M)” hereinafter. According to the production method (M), it is possible to produce the capacitor (C). However, the capacitor (C) may be produced using a production method other than the production method (M).

The production method (M) includes a step (i) and a step (ii). The step (i) is a step of forming a conductive layer (L) on a dielectric layer formed on a surface of the anode body. The step (i) includes a step (i-a) of forming the first conductive layer on the dielectric layer, and a step (i-b) of forming the second conductive layer on the first conductive layer.

There is no particular limitation on the method for forming the first and second conductive layers, and the first and second conductive layers may be formed using a known method. Examples of the method for forming these layers include a gas phase method for forming a layer in a gas phase or a liquid phase method for forming a layer in a liquid phase. Examples of the gas phase method include a vapor deposition method, a sputtering method, an atomic layer deposition method (ALD method), and a chemical vapor deposition method (CVD method). Examples of the liquid phase method include a sol-gel method, a chemical bath deposition method, a hydrothermal method, a flux method, a coating method, an electroplating, and electroless plating. It is preferable to select these methods in consideration of the material of a conductive layer.

The first conductive layer is preferably formed using a method with which a high coverage is provided (high coverage method) even when its surface has unevenness. In particular, when the anode body has a porous portion in its surface, it is preferable to form the first conductive layer using a high coverage method. Examples of a high coverage method include the ALD method.

A preferable example of a method for forming a second conductive layer is a liquid phase method. The liquid phase method is preferable because it is low cost and a film is likely to be formed inside a porous portion.

In a preferable example, the first conductive layer is formed using the ALD method, and the second conductive layer is formed using the liquid phase method. In a preferable example of a conductive layer, the first conductive layer is made of ZnO formed using the ALD method, and the second conductive layer is made of ZnO formed using the liquid phase method.

The step (ii) is a step of forming a cathode extraction layer on a second conductive layer. A capacitor element can be obtained through the steps (i) and (ii). After the step (ii), a step of connecting a lead to a capacitor element and a step of covering the capacitor element with an exterior body are performed as needed. A capacitor (C) is produced in this manner. Note that, when the capacitor (C) includes a plurality of capacitor elements, the production method (M) includes a step of connecting the plurality of capacitor elements to each other.

Examples of the configuration and constituent members of the capacitor (C) will be described below. Known constituent members may be applied to constituent members other than those of distinctive parts of the present disclosure.

### Anode Body

An anode body can be formed using a valve metal, an alloy containing a valve metal, a compound containing a valve metal, or the like. These materials may be used alone or in a combination of two or more. Aluminum, tantalum, niobium, or titanium is preferably used as a valve metal. A foil (e.g., a metal foil such as an aluminum foil) made of the above-mentioned material may be used as an anode body.

An anode body having a porous portion in its surface can be obtained by, for example, roughening the surface of a metal foil containing a valve metal. Roughening may be performed through electrolytic etching or the like.

Alternatively, the anode body may be formed by sintering particles made of the above-mentioned material. For example, the anode body may be a sintered body of tantalum. When the anode body is a sintered body, a porous portion is present in a surface of the anode body. When the anode body is a sintered body, the capacitor (C) may include an anode wire whose portion is embedded in the sintered body.

### Dielectric Layer

A dielectric layer is an insulating layer that functions as a dielectric. The dielectric layer may be formed by anodizing a valve metal of the surface of the anode body (e.g., a metal foil). It is sufficient that the dielectric layer is formed to cover at least a portion of the anode body. The dielectric layer is usually formed on the surface of the anode body. When a porous portion is present in the surface of the anode body, the dielectric layer is formed on the surface of the porous portion of the anode body.

A typical dielectric layer includes an oxide of a valve metal. For example, a typical dielectric layer when tantalum is used as a valve metal contains Ta₂O₅, and a typical dielectric layer when aluminum is used as a valve metal contains Al₂O₃. Note that the dielectric layer is not limited to this, and may be any dielectric layer that functions as a dielectric.

### Cathode Extraction Layer

The cathode extraction layer is a conductive layer. The cathode extraction layer may be formed using conductive carbon or a metal. Specifically, the cathode extraction layer may be formed using a carbon paste containing conductive carbon particles or a metal paste containing metal particles. Alternatively, the cathode extraction layer may include a layer made of only a metal (a vapor deposition layer or a metal foil). Examples of conductive carbon include graphite, carbon black, graphene flakes, and carbon nanotubes. Examples of the metal paste include a silver paste containing silver particles.

The cathode extraction layer may include a first layer formed on the conductive layer (L), and a second layer formed on the first layer. In such a case, the first layer may be a carbon layer containing conductive carbon, and the second layer may be a layer formed of a metal paste.

### Lead Member and Exterior Body

There is no particular limitation on a lead member and an exterior body, and a known lead member and a known exterior body may be used.

### Structure of Capacitor (C)

The capacitor (C) may include only one capacitor element. Alternatively, the capacitor (C) may include a plurality of capacitor elements. For example, the capacitor (C) may include a plurality of capacitor elements connected in parallel to each other. The plurality of capacitor elements (C) are usually connected in parallel in a stacked state, and are covered with the exterior body.

An example of an embodiment according to the present disclosure will be specifically described below with reference to the drawings. The above-described constituent elements can be applied to exemplary constituent elements described below. Also, the example described below can be modified based on the above description. Further, items described below may be applied to the above embodiment. Also, in the embodiment described below, constituent elements that are not essential to the capacitor according to the present disclosure may be omitted. Note that the figures below are illustrative and may differ from the actual configuration.

### Embodiment 1

FIG. 1 is a cross-sectional view schematically showing a capacitor according to Embodiment 1. A capacitor 10 shown in FIG. 1 includes a capacitor element 100, an anode lead 21, a cathode lead 22, a metal paste layer 23, and an exterior body 30.

The capacitor element 100 includes an anode body 111, a dielectric layer 112, a conductive layer 120, and a cathode extraction layer 131. The dielectric layer 112 is formed to cover at least a portion of the surface of the anode body 111. The conductive layer 120 is formed to cover at least a portion of the dielectric layer 112. The cathode extraction layer 131 is formed to cover at least a portion of the conductive layer 120. The conductive layer 120 is the above-described conductive layer (L).

The anode lead 21 is connected to the anode body 111. The cathode lead 22 is connected to the cathode extraction layer 131 via the metal paste layer 23. The metal paste layer 23 is formed of a metal paste (silver paste). The exterior body 30 is formed to cover a portion of the anode lead 21, a portion of the cathode lead 22, and the capacitor element 100. A portion of the anode lead 21 and a portion of the cathode lead 22 are exposed from the exterior body 30, and function as terminals.

FIG. 2 is a schematic cross-sectional view of an example of a portion where the conductive layer 120 is present. The exemplary anode body 111 shown in FIG. 2 has a porous portion 111a in its surface. As shown in FIG. 2, the conductive layer 120 includes a first conductive layer 121 formed on the dielectric layer 112, and a second conductive layer 122 formed on the first conductive layer 121. The average thickness of the second conductive layer 122 is larger than the average thickness of the first conductive layer 121.

FIG. 1 shows a case where the capacitor 10 includes one capacitor element 100.

However, the capacitor 10 may include a plurality of capacitor elements 100. FIG. 3 shows a schematic cross-sectional view of an example of the capacitor 10 including the plurality of capacitor elements 100. Note that some members are not shown in FIG. 3 to make FIG. 3 easy to read.

The capacitor 10 shown in FIG. 3 includes a plurality of capacitor elements 100 stacked on each other. The plurality of capacitor elements 100 are connected in parallel.

### EXAMPLES

An aluminum foil having a porous portion in its surface was prepared as an anode body. A conductive layer was formed on the aluminum foil using two methods. In the first method, a thick ZnO layer was formed using only a liquid phase method. In the second method, a thin ZnO layer (first conductive layer) was formed using the ALD method, and a thick ZnO layer was formed using a liquid phase method. Regarding the conductive layer formed using the first method and the conductive layer formed using the second method, a cross section of a porous portion was subjected to SEM-EDS measurement. An intensity ratio Zn/Al of Zn to Al was determined using the measurement results. As a result, when the conductive layer was formed using the first method, the intensity ratio Zn/Al was 0.04, and when the conductive layer was formed using the second method, the intensity ratio Zn/Al was 0.18. This result suggests that the coatability of a conductive layer in the porous portion is improved by forming the first conductive layer using the ALD method.

### INDUSTRIAL APPLICABILITY

The present disclosure can be used for a capacitor.

Although the present invention has been described in terms of the presently preferred embodiments, it is to be understood that such a disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### REFERENCE SIGNS LIST

10: capacitor, 21: anode lead, 22: cathode lead, 30: exterior body, 100: capacitor element, 111: anode body, 111a: porous portion, 112: dielectric layer, 120: conductive layer, 121: first conductive layer, 122: second conductive layer, 131: cathode extraction layer

1. A capacitor comprising:
an anode body having a dielectric layer formed on a surface of the anode body; and
a conductive layer formed on the dielectric layer and made of a metal oxide,
wherein the conductive layer includes a first conductive layer formed on the dielectric layer, and a second conductive layer formed on the first conductive layer, and
an average thickness of the second conductive layer is larger than an average thickness of the first conductive layer.

2. The capacitor according to claim 1, further comprising
a cathode extraction layer formed on the conductive layer and containing an inorganic conductive material.

3. The capacitor according to claim 1,
wherein the average thickness of the first conductive layer is in a range of 1 nm to 1 μm.

4. The capacitor according to claim 1,
wherein the anode body includes a porous portion in the surface of the anode body, and
the dielectric layer is formed on the porous portion.

5. The capacitor according to claim 1,
wherein the second conductive layer has a conductivity of 1 S/cm or more.

6. The capacitor according to claim 1,
wherein the conductive layer is made of at least one selected from the group consisting of ZnO, TiO₂, indium tin oxide, In₂O₃, SnO₂, MnO₂, NiO₂, CuInO₂, CuCrO₂, CuAlO₂, and CuScO₂.

7. The capacitor according to claim 1,
wherein the conductive layer contains an impurity element for improving conductivity of the conductive layer.
